(19) United States
(12) Patent Application Publication
(10) Pub. No.: US 2014/0313904 A1
(43) Pub. Date: Oct. 23, 2014

(54) System and Method of Device Based Cached Rules

(71) Applicant: CrowdCare Corporation, Richmond Hill (CA)

(72) Inventors: Jeffrey Brunet, Aurora (CA); Ian Collins, Markham (CA); Yousuf Chowdhary, Maple (CA); Karen Chan, Richmond Hill (CA)

(73) Assignee: CrowdCare Corporation, Richmond Hill (CA)

(21) Appl. No.: 14/256,640

(22) Filed: Apr. 18, 2014

Related U.S. Application Data
(60) Provisional application No. 61/854,050, filed on Apr. 18, 2013.

(51) Int. Cl. H04L 12/24

(52) U.S. Cl. CPC H04L 41/5061; H04L 41/5038
USPC 370/241

(57) ABSTRACT

A method is provided for self-care based customer care for users of devices. A device agent is provided for the device. The device agent is executable on the device and is programmed for gathering information from the device in the form of a device profile and running a diagnosis of the device. The diagnosis process refers to a set of rules stored locally on the device, and aspects of the device profile are reviewed against conditions in these rules. The profile gathering and diagnosis steps are programmed to be triggered and occur on the device.

### CROSS-REFERENCE TO RELATED APPLICATIONS

This application claims the benefit of U.S. Provisional Patent Application No. 61/854,050, filed Apr. 18, 2013 and entitled “System and Method of Device Based Cached Rules”, which is incorporated herein by reference in its entirety.

### FIELD OF INVENTION

The invention relates to customer care systems for electronic devices and more particularly relates to customer care systems for electronic communication devices.

### BACKGROUND OF THE INVENTION

The current method of gathering and obtaining device information required for diagnostics is manual and therefore complex, time-consuming and prone to human errors. In the course of a customer care session for a device, a CSR (Customer Service Representative) must undertake the extensive and time-consuming task of asking the user complex questions pertaining to the user's wireless device for problem diagnosis. This requires CSRs to be experts on many types of devices and their applications, and also requires users to spend increased time on the telephone to receive support for their applications. The result is increased support costs, increased call handling times, complex diagnostic processes and overall frustration.

One prior art method to overcome the above issues is self-care, whereby information is provided to the users and they can use the information to resolve some of the basic issues themselves, thus helping reduce some of the costs. Such prior art methods still lack automation and the user is required to sift through massive amounts of data manually to get to the relevant information. Such central knowledge-bases can also become a single point of failure. Additionally in order to use these online resources the (mobile) device must have data connectivity so that it can connect to the internet. On the server side, such centralized systems can require a tremendous amount of computing power and bandwidth to handle the multiple requests originating from a large number of mobile devices.

Thus we note that prior art methods have inherent limitations and are in need of improvement.

### SUMMARY

The present system enables computing to be pushed to the edge of the network. A codified knowledgebase is provided where rules are used to diagnose a problem and/or fine tune the performance of various types of devices. Briefly stated, self-care can be provided to a device using a subset of rules which are cached to the device. An agent or an app on the device executes these local rules. This enables a device to run a self-diagnosis without requiring any network connection and without the need to incur data download fees. This also reduces the need for computing power and bandwidth requirements on the server side, as it avoids the huge amount of traffic that can be caused by millions of devices encountering a common issue and trying to connect to the server for a remedy. Thus we note that the present system and method provides a meaningful benefit by providing a local cache of rules that can be executed when resolving issues.

Devices that can benefit from the system may include but are not limited to a computer, a server, network appliance, set-top box, SmartTV, embedded device, computer expansion module, personal computer, laptop, tablet computer, personal data assistant, game device, e-reader, a mobile device for example a Smartphone, any appliances having internet or wireless connectivity and onboard automotive devices such as navigational and entertainment systems.

The local cache of the rules on a device can be periodically updated by either providing a push mechanism where the server is able to push specific new rules to specific devices. In another embodiment, the occurrence of an event on the device may trigger the device connecting to the master rules repository to pull an update.

According to a first aspect of the invention, a method is provided of providing self-care based customer care to a user of a device. A device agent is provided for the device. The device agent is capable of running on the device, and is programmed for: gathering information from the device in the form of a device profile; and running a diagnosis of the device. The diagnosis is with regard to a set of rules stored locally on the device. Aspects of the device profile are reviewed against conditions in the rules. The gathering and running a diagnosis steps are programmed to be triggered and occur on the device.

Preferably, the set of rules was previously provided to the device (i.e. before the diagnosis) as a subset of a larger set of rules. The subset is preferably a subset of rules selected as relevant based on particulars of the device. For example, the subset may be relevant based on the make and model of the device, or based on at least one service or service provider relevant to the device.

Preferably, the device agent includes an editor (provided as a separate editor or simply rule editing/authoring functionality within the device agent application itself) for permitting the user to personalize or edit the rules on the device. Examples of personalization include setting tolerance ranges for desired functionality of the device, setting priorities among features or functions, and scheduling of maintenance tasks.

Preferably, running a diagnosis further includes providing a fix to the device. A “fix” is used broadly here to refer to any recommended course of action with respect to a device (including without limitation, changes in settings, installation or removal of hardware, software or firmware, physical changes, and service/plan changes). For example, the fix may comprise providing a programmed solution to a diagnosed problem, or conforming a setting or value in the device profile to a reference setting or value, or resetting a setting or value to a default setting or value, or turning on or off a feature or executing or shutting down an application on the device. In some embodiments, the fix may comprise simply displaying a notification on the device.

Preferably, the device agent is further programmed for periodically receiving updated rules on the device. The updated rules may be received on the device in response to a request from the user or the device. The updated rules may be received on the device at a predetermined interval or as available from a rules author.

Likewise, running a diagnosis may be programmed to occur at predetermined intervals. Running a diagnosis may also be programmed to occur in response to a user or device request.

Preferably, the device agent is programmed for running a diagnosis without transmitting information or device profiles outside the device.

Preferably, the device agent is programmed for running a diagnosis without the device having an active network connection.

According to a second aspect of the invention, a method is provided of providing self-care based customer care to a user of a device. The device has a device agent capable of running on the device and is programmed for gathering information from the device in the form of a device profile for diagnosing problems on the device and suggesting fixes. A set of rules is authored by an author and is selectively pushed, or selectively allowed to be pulled, to the device, based on relevancy of the rules to the device. These rules are provided in a form so as to be storable locally on the device and referable by the device agent on the device in diagnosing problems and suggesting fixes.

Preferably, the author is selected from the group consisting of: a device manufacturer, a hardware provider, a service provider, a software developer, a software user, a hardware user, a device user, and a crowd of one or more of the foregoing.

### BRIEF DESCRIPTION OF THE FIGURES

FIG. 1 is a flow diagram illustrating the creation and dissemination of rules and rules subsets according to an aspect of the present invention.

FIG. 2 is a network diagram illustrating rules storage according to an aspect of the present invention.

FIG. 3 is a flow diagram of the use of personalized rules on a device according to an aspect of the present invention.

FIG. 4 is a flow diagram of event-based triggering of local rules according to an aspect of the present invention.

FIG. 5 is a flow diagram of updating local rules according to an aspect of the present invention.

FIG. 6 is a flow diagram of selectively pushing rules to a device according to an aspect of the present invention.

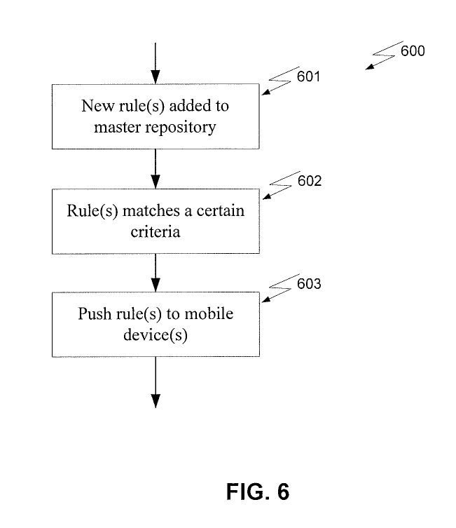

### DETAILED DESCRIPTION

Before embodiments are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on a mobile device or partly on the mobile device as a stand-alone software package; partly on the mobile device and partly on a remote computer or entirely on the remote computer or server. In the latter scenario, the remote computer may be connected to the mobile device through any type of network, including a local area network (LAN) or a wide area network (WAN), or the connection may be made to the internet through a mobile operator network (e.g. a cellular network).

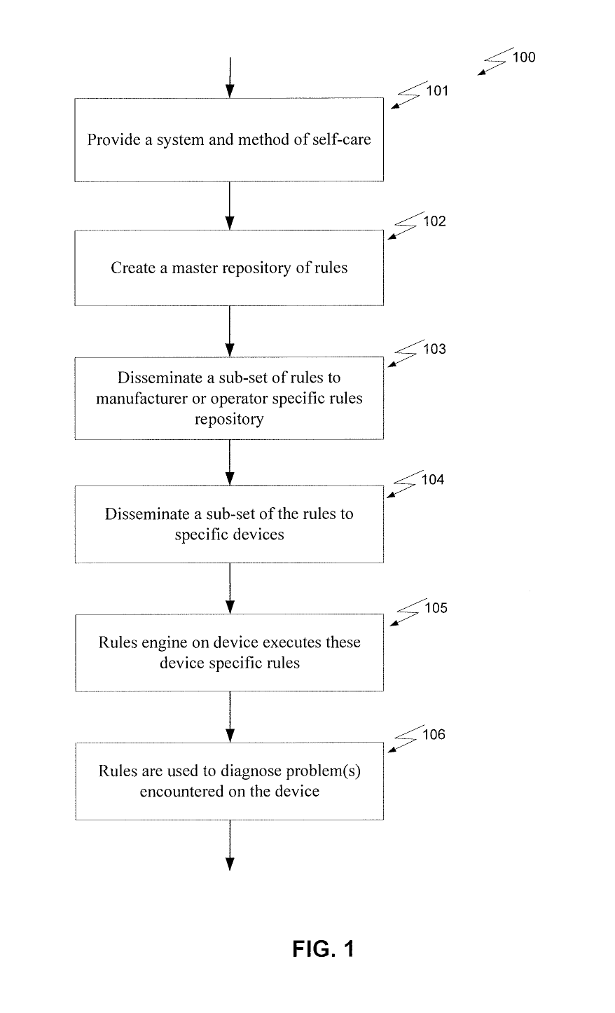

FIG. 1 is a flow diagram of certain overarching concepts of the present method.

A system and method of self-care is provided 101. Customers no longer want to call service providers to make changes to their services or to get some basic problem resolved. Web based self-care systems are able to deliver a more convenient, always-on, communication channel that helps lower cost of customer service and reduces staff workload, by eliminating many routine customer service calls. Self-care enables customers to check their balances, view financial transactions and invoices, modify personal details, change billing cycle dates, modify payment methods, change service parameters, and most importantly trouble shoot some of the basic issues that they may encounter. The present system and method provides a self-care system that enables computing to be pushed to the edge of the network, eliminating the need to connect to a remote server to fix an problem, thus reducing the computing power and bandwidth needed at the server side, eliminating the data costs on the device side and reducing expense and increasing the overall efficiency of the system.

A master repository of rules is created 102. The master rules repository contains the domain knowledge coded in the form of rules. A rule consists of some number of conditions and some number of actions. Generally the rules are written in a high-level business language that relates to the domain, storing the rules in the repository. The Rules Repository may also include proto-rules i.e. rules not completely validated yet for implementation. A database may be used as the preferred and exemplary embodiment to store the rules. In another embodiment the rules may be stored in a list, in a table or other method that may be suitable for so doing.

A rule can generally be represented as IF CONDITION(S) THEN RECOMMENDATION(S)/FIX(ES). It can consist of one or more conditions (the “IF”). One or more conditions can be grouped together by “and” and “or” and the order of operations can be further defined using brackets. In each condition, there could be a device attribute, a conditional operator (=, >, <, !=, exists, not exists) and then a text box in which to enter static text, numeric, date-time value or another device attribute. These conditions can then be rearranged, grouped, and joined together to form a bigger condition.

A rule should also contain a recommendation or a fix (the “THEN”). When saved, the rules will follow a Rules Lifecycle (status including but not limited to DRAFT, PENDING, VALIDATION, REJECTED, VALIDATED (Nth), ACTIVE, INACTIVE) and only active rules may be disseminated to other sources. The scope of a rule can be system-wide, device-specific, model-specific, manufacturer-specific, operator-specific etc.

From this master repository, a subset of rules can be disseminated to manufacturer or operator specific multiple rules databases 103. There may be several methods of disseminating the rules from the master rules repository to the manufacturer or operator specific rules repositories. In one embodiment a subset of rules may be pushed from the master rules repository to the manufacturer or operator specific rules repositories. In another embodiment a subset of the rules may be pulled by the manufacturer or operator specific rules repositories from the master rules repository. The push or the pull may be based on either a schedule or may be based on meeting some pre-set conditions. The invention is not limited to these exemplary embodiments.

A further (even more specific) subset of the rules may then be disseminated to specific mobile devices 104. There may be several methods of disseminating the rules from the manufacturer or operator specific rules repositories to the specific mobile devices. In one embodiment a subset of rules that are relevant to a specific make and model of a device may be pushed from the manufacturer or operator specific rules repositories to that specific make and model of the device. In another embodiment a subset of the rules may be pulled by the device from the manufacturer or operator specific rules repositories. The push or the pull may be based on either a schedule or may be based on meeting some pre-set conditions. The invention is not limited to these exemplary embodiments.

Once on a mobile device these rules can be executed by a rules engine 105. Rules are used to diagnose a problem and/or fine tune the performance of the mobile device 106. The rules engine can be embedded in the device agent or an application (specific to customer care, or having another purpose). The rules engine and device agent can also be modules that are called by an application.

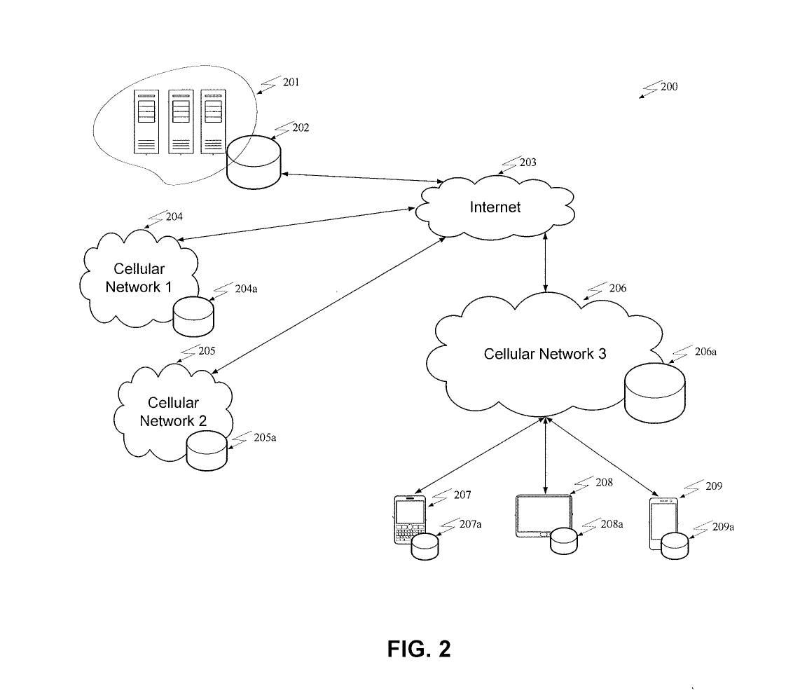

FIG. 2 shows an exemplary network diagram of the present system of invention along with other associated components 200. In one embodiment, the system includes online server(s) 201 that may preferably house the master repository of rules 202. In one embodiment there may preferably also be a rules authoring interface (not shown) which allows rules to be created and edited/validated through the various stages of the rule life-cycle. One example of a rules authoring interface is shown and described in U.S. patent application Ser. No. 13/968,631 of the same applicant, the disclosure of which is incorporated herein by reference.

The online server(s) 201 may be connected to the Internet 203 for providing an online access method. The figure shows three cellular networks Cellular Network1 204 and Cellular Network1 specific repository of rules 204a; Cellular Network2 205 and Cellular Network2 specific repository of rules 205a; Cellular Network3 206 and Cellular Network3specific repository of rules 206a.

A subset of rules from the Cellular Network3 206 and Cellular Network3 specific repository of rules 206a are disseminated to Mobile Device 207 and Mobile Device specific local repository of rules 207a; Mobile Device 208 and Mobile Device specific local repository of rules 208a; Mobile Device 209 and Mobile Device specific local repository of rules 209a.

Thus Mobile Device 207 will have a subset of rules in the Mobile Device specific local repository of rules 207a that are only relevant to the specific device. This subset of rules may be narrowed down from the Cellular Network3 specific repository of rules 206a by filtering based on the make and model of Mobile Device 207, its operating system, operating system version, language of user etc.

Similarly Mobile Device 208 will have a subset of rules in the Mobile Device specific local repository of rules 208a that are only relevant to the specific device.

And Mobile Device 209 will have a subset of rules in the Mobile Device specific local repository of rules 209a that are only relevant to the specific device.

There may also be a device manufacturer specific repository of rules, where only rules pertaining to the devices that are manufactured by this particular manufacturer are stored. The device manufacturer may preferably load these rules into the devices at the time of manufacture. Alternately the manufacturer provides a mechanism for these rules to be downloaded and periodically updated on the devices via the internet or other network connectivity.

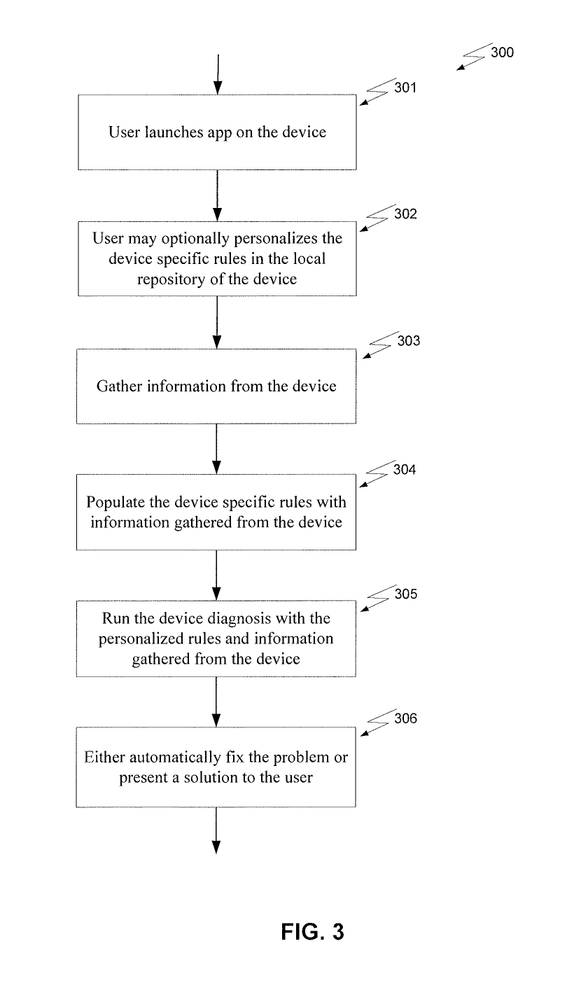

Turning to FIG. 3, an embodiment of the method with user personalization is illustrated. The user launches an app on the device 301. In one embodiment the app on the device has the logic to apply rules from the device based cached Rules Repository to identify inaccuracies and inconsistencies. These rules may be used to either fix a problem that has been encountered on the device or may be used to fine tune the performance of the device so that it better utilizes the computing resources and services that it consumes.

The user can personalize the device specific rules in the local device repository of rules 302. In one embodiment the user may personalize the rules for personal taste, location, situation, schedules, etc.

Information is gathered from the device 303. Examples of the information that can be gathered from the mobile device include, but are not limited to: the device model and manufacture information; applications (commonly referred to as “apps”) installed on the device; apps and processing running on the device; certificates on the device; user profile information; the character of any passcode used to authenticate a user (e.g. whether a password/passcode is used and the relative strength of that password, such as the number of characters); operating system of the device; information regarding whether the device operating system has been tampered with by the user (e.g. an iOS device has been jailbroken, or a Google Android device has been rooted); and the data usage e.g. the amount of MB or GB used for a given billing period, the amount data used while roaming, or the relative amount compared to a data plan used by the user—which may be useful for monitoring or controlling costs when paying for data usage.

The device specific rules are then populated with information gathered from the device 304. In one embodiment populate these device specific/personalized rules are populated with local/transient information gathered from the device (for example location, device condition, battery level, available free space, signal strength, is device in Airplane mode, installed apps, running apps etc).

The device diagnosis is run with the personalized rules and information gathered from the device 305. In one embodiment each rule may embody the actual, required values for the different fields e.g. SMTP Server, Gateway IP addresses, APN, Build Versions, User name, Passwords, list of malicious apps, etc. The actual values may be seeded in a rule or could be obtained from another source either on the server or on the device. In one embodiment the execution of the rules allows for the comparison of the values found on the device with the values in the rules. If the values are the same, i.e. the value of a field in the device and the value of the field in the rule are equal, it is concluded that the rule has passed and that no fix may be required. If the two values (i.e. the value of a field in the device and the value of the field in the rule) are NOT equal it is concluded that the device is in need of a fix, and the value of the field in the device is replaced with the value of field in the rule.

In one embodiment a rule may embody a condition and may use some of the information that has been used to personalize the rule as well as the information gathered from the device. The rules may also preferably use reference values, standard values, target values, a range of values etc. to compare and replace values of a field on the device.

The problem can then either be automatically fixed or a solution presented to the user 306. In one embodiment (as explained above) the value of a field from a rule can be assigned to replace the value of a field in the device. Alternatively, a solution can be provided where the user may be able to edit, add, delete, modify etc. the values required in a field. In another embodiment information can be presented to the user e.g. a notification or a tutorial or a roaming FAQ; alternatively a remedy can be suggested to the user as a course of action. In another embodiment the performance of the device can be fine tuned for better utilization of existing computing power and services being consumed.

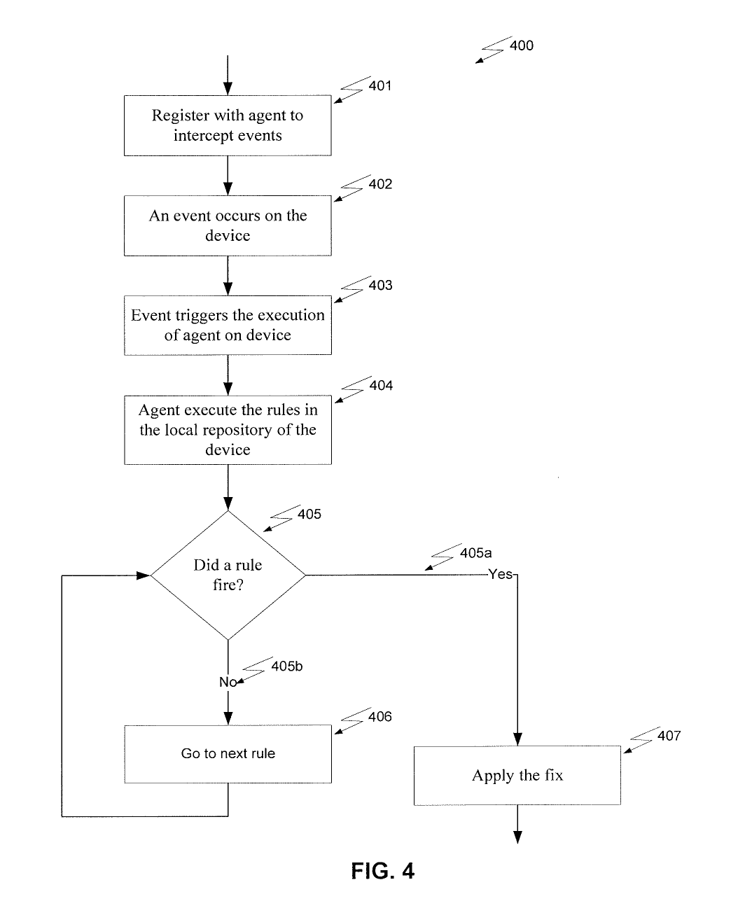

Turning to FIG. 4, an embodiment of the method with event based triggering is illustrated. The app may have the agent and the rules engine embedded in it while also providing a user interface using which a user may be able to register the events with the app. The user may thus register with the device agent to intercept events 401. Registering to intercept events may include making and setting new or modified thresholds for some or all of the rules. For example a rule may provide a mechanism whereby when the battery level goes below a certain point it may close some of the applications and services that are running in the background to prolong the battery life. Thus the user may have the option to define the battery level that triggers this rule (for example—when battery is down to 10%, execute this rule) while also defining what applications and services to close.

The system notes when the event occurs on the device 402. For example the battery level reaches 10%, or free space on the device hits less than 15%. In one embodiment a singular event may trigger this process. In another embodiment an occurrence of a first event on a device may await a second event before any action is taken.

The event triggers the execution of the agent on the device 403. The agent executes the rules in the local rules cache of the device 404. In one embodiment the rules in the local cached repository of the device are executed. In one embodiment the cached rules repository may also have a cache of information gathered from the device as elaborated in FIG. 3, step 303. This information gathered from the device may be updated on a periodic basis so that it is relatively fresh when it is used. In an alternate embodiment the information is gathered from the device in real time to ensure that is the most accurate and current set of information.

The system checks whether a rule fired 405. If a rule did not fire (No 405b), then the system goes on to the next rule 406. Similarly the system may cycle through the entire local rules repository, one rule after another. If a rule fired (Yes 405a) then the fix can be applied. In one embodiment a solution can be provided where the user may be able to edit, add, delete, modify etc. the values required in a field. In another embodiment information can be presented to the user e.g. a notification or a tutorial or a roaming FAQ; alternatively a remedy can be suggested to the user as a course of action. In another embodiment the performance of the device can be fine tuned for better utilization of existing computing resources and services being consumed.

In one embodiment if no rules fire and no remedy is available, the user may be prompted to connect to the online master rules repository to either get an update of the rules or to be able to execute the rules residing on the server side. This process may be user initiated or may begin automatically depending on a number of factors including user preferences, settings etc.

It is to be understood that the rules engine is not necessarily linear when executing the rules. There may be a common starting point when executing the rules, but as the rules are executed and as information gathered from the device is analyzed, one rule may trigger another rule that may be part of another set of rules. There may also be loops, so that there are rules embedded within rules, or a rule may call another rule as part of its execution. The rule that is called from within the loop or the rule that is called as part of the execution of another rule may not fixed or static but may depend on the situation and vary as needed.

It is to be understood that these are exemplary methods and there may be other methods that are commonly used and obvious to the one skilled in the art. The intent is to cover all such methods that may be used to implement the method.

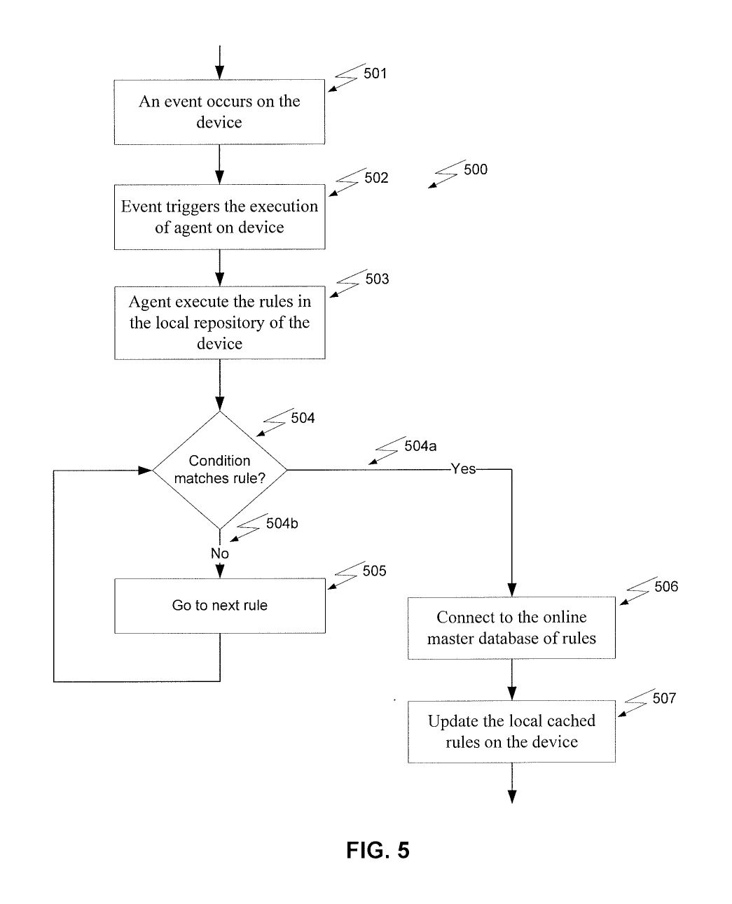

FIG. 5 illustrates a flow of updating rules according to one embodiment. An event occurs on the device 501, for example the user moves from an operator data connection to a WiFi data connection.

The event may then trigger the execution of a rules engine on device 502. In one embodiment an event like moving from a cellular network data coverage to a WiFi network coverage may trigger the execution of the rules engine on the device. There may be other events that trigger the execution of the rules engine and the intent is to cover all such possible events. The device agent executes the rules in the local rules repository of the device 503. The system checks whether the condition matches rule 504. If no matching condition is found in a rule (No 504b) then the system proceeds to the next rule 505. If a condition matches a rule (Yes 504a) then the system connects to the online master repository of rules 506.

The local cached rules on the device can be updated 507 for example to add new rules, delete old rules, update the resolutions etc.

In some embodiments, these steps may be repeated as often as necessary to keep the cached rules on a mobile device up to date. Thus for example in one embodiment these steps may be repeated every few minutes, or once an hour or once a day while in another embodiment they may be repeated once a week, while in another embodiment they may be repeated once a month or every time there is a defined event e.g. when the device connects to a WiFi network. In an alternate embodiment this frequency may be customizable while in another embodiment the frequency may be based on the rate of failures encountered by the mobile device. In yet another embodiment these updates may be pushed to the mobile device if they are considered to be urgent or critical.

The system allows new rule(s) to be added to the master rules repository 601. In one embodiment the system may provide a Rules Authoring user interface (UI) that may consist of an input page with drop-downs and text input boxes or it may be a UI that is based off the device profile view or comparison view where the rule author can pick and choose the conditions to build the CONDITIONS and the RECOMMENDATIONS/FIXES. For the purpose of the master rules repository, the rules authors can be anyone—including a device manufacturer, a hardware provider, a service provider, a software developer, a software user, a hardware user, a device user. The “crowd” can also be considered an author. These rules will typically proceed through a life-cycle and some may be refined or rejected before publication depending on the outcome of validation.

The system confirms that the rules match a certain criteria 602. In one embodiment at pre-configured intervals, newly published rules can be re-evaluated against the latest device profile of end users/subscribers who opted for proactive updates to the local rules cache.

Appropriate rules are then pushed to the mobile device 603. In one embodiment a new rule available notification or a new fix available notification may be pushed to the device and the device agent can connect to the master repository of rules or the device manufacturer/operator specific rules repository to fetch the new rules. Similarly the system can update the local rules cache on the mobile device, adding new rules, deleting old rules, updating the ones that have been modified etc.

It should be understood that although the term application has been used as an example in this disclosure but in essence the term may also apply to any other piece of software code where the embodiments are incorporated. The software application can be implemented in a standalone configuration or in combination with other software programs and is not limited to any particular operating system or programming paradigm described here. Thus, it is intended to cover all applications and user interactions described above as well as those obvious to persons skilled in the art.

Several exemplary embodiments/implementations have been included in this disclosure. There may be other methods obvious to persons skilled in the art, and the intent is to cover all such scenarios. The application is not limited to the cited examples, but the intent is to cover all such areas that may be benefit from this invention.

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to persons skilled in the art.

1. A method of providing self-care based customer care to a user of a device, comprising:
providing a device agent for the device, capable of running on the device, and being programmed for:
gathering information from the device in the form of a device profile; and
running a diagnosis of the device having regard to a set of rules stored locally on the device by reviewing aspects of the device profile against conditions in the rules;
wherein the gathering and running a diagnosis steps are programmed to be triggered and occur on the device.

2. The method of claim 1, wherein the set of rules was previously provided to the device as a subset of a larger set of rules, the subset having been selected as relevant based on particulars of the device.

3. The method of claim 2, wherein the particulars include the make and model of the device.

4. The method of claim 2, wherein the particulars include at least one service or service provider relevant to the device.

5. The method of claim 1, wherein the device agent comprises an editor for permitting the user to personalize or edit the rules on the device.

6. The method of claim 1, wherein running a diagnosis further comprises providing a fix to the device.

7. The method of claim 6, wherein the fix comprises providing a programmed solution to a diagnosed problem.

8. The method of claim 6, wherein the fix comprises conforming a setting or value in the device profile to a reference setting or value, or resetting a setting or value to a default setting or value.

9. The method of claim 6, wherein the fix comprises turning on or off a feature or executing or shutting down an application on the device.

10. The method of claim 6, wherein the fix comprises displaying a notification on the device.

11. The method of claim 1, wherein the device agent is further programmed for periodically receiving updated rules on the device.

12. The method of claim 11, wherein the updated rules are received on the device in response to a request from the user or the device.

13. The method of claim 11, wherein the updated rules are received on the device at a predetermined interval or as available from a rules author.

14. The method of claim 1, wherein running a diagnosis is programmed to occur at predetermined intervals.

15. The method of claim 1, wherein running a diagnosis is programmed to occur in response to a user or device request.

16. The method of claim 1, wherein the device agent is programmed for running a diagnosis without transmitting information or device profiles outside the device.

17. The method of claim 1, wherein the device agent is programmed for running a diagnosis without the device having an active network connection.

18. A method of providing self-care based customer care to a user of a device, the device having a device agent capable of running on the device and being programmed for gathering information from the device in the form of a device profile for diagnosing problems on the device and suggesting fixes, the method comprising:
authoring a set of rules by an author and selectively pushing the rules, or selectively allowing the rules to be pulled, to the device, based on relevancy of the rules to the device,
the rules being provided in a form so as to be storable locally on the device and referable by the device agent on the device in diagnosing problems and suggesting fixes.

19. The method of claim 18, wherein the author is selected from the group consisting of: a device manufacturer, a hardware provider, a service provider, a software developer, a software user, a hardware user, a device user, and a crowd of one or more of the foregoing.
